(19) United States
(12) Patent Application Publication
(10) Pub. No.: US 2007/0108224 A1
(43) Pub. Date: May 17, 2007

(54) Method for dispensing a food product

(76) Inventors: Iain James Campbell, Shambrook (GB); James Francis Crilly, Shambrook (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/580,732

(22) PCT Filed: Oct. 15, 2004
(86) PCT No.: PCT/EP04/11682

§ 371 Date: May 25, 2006

(30) Foreign Application Priority Data
Nov. 25, 2003 (EP) 03257429.5

(51) Int. Cl. G01F 11/00

(52) U.S. Cl. 222/1

(57) ABSTRACT

Ice cream is dispensed from an apparatus comprising holding means for an ice cream container under pressure. Actuating means open and close on request a valve of the ice cream container, thus delivering individual portions of ice cream.

### TECHNICAL FIELD OF THE INVENTION

This invention relates to a method for dispensing a for dispensing a food product. The invention particularly relates to a method for dispensing soft ice cream.

### BACKGROUND

It has been proposed to dispense ice cream from large containers in individual portions by, for example, hand operation using scoops. It has also been proposed to dispense ice cream from machines as by soft serve machines in which the product is mixed, and frozen, or by dispensing machines in which pre-packaged ice cream is delivered from an ice cream container.

Conventional soft ice is dispensed from a semi-continuous, pressurised scraped surface heat exchanger (SSHE) at temperatures of −4 to −9° C. The rheology of ice cream and the shear provided by the SSHE are such that a pressure of a few atmospheres is sufficient to dispense the ice cream at an acceptable rate. Unfortunately, SSHEs are large and expensive, require power, training to operate, do not deliver consistent product quality if used over a period of time & are difficult to dismantle & clean for the operator. Each SSHE can also only offer one type of product (e.g. flavour/ice cream/sorbet etc) at a time—separate barrels are required for different products.

All these known systems are limited by one or more factors such as expensive machinery, slow rate of dispensing, narrow range of product, deterioration of bulk product not used, consistency of portion control, limited flavour selection etc.

Other, more recent dispensing systems use cartridges of ice cream that must be kept at frozen temperatures (often higher than regular deep freeze temperatures of −18 to −22° C.) locally separate to the dispensing system. Here the ice cream is not under pressure and therefore the volume in the cartridge is at most the volume of product dispensed, therefore systems take up a bigger footprint. Such dispensing systems are for example described in WO91/01090.

There is therefore a need for a portable business system that supplies multi-portion freshly-dispensed where no power is available locally in a compact, easy to use, hygienic system. The compressed format of the system means the capacity to deliver higher volumes of product for the same stored volume compared to other pre-frozen, aerated products.

Tests and Definitions.

Average Molecular Weight

For the purposes of this patent, the average molecular weight for a mixture of freezing point depressants (fdps) is defined by the number average molecular weight <M>ₙ (equations). Where wᵢ is the mass of species i, Mᵢ is the molar mass of species i and Nᵢ is the number of moles of species i of molar mass Mᵢ.

$$< M {>}_{n} = \frac{\sum {w}_{i}}{\sum ( {w}_{i} / {M}_{i} )} = \frac{\sum {N}_{i} {M}_{i}}{\sum {N}_{i}}$$

Freezing Point Depressants

Freezing point depressants (fpds) as defined in this invention consist in:
monosaccharides and disaccharides
Oligosaccharides containing from 3 to ten monosaccharide units joined in glycosidic linkage.
Corn syrups with a dextrose equivalent (DE) of greater than 20 preferably >40 and more preferably >60. Corn syrups are complex multi-component sugar mixtures and the dextrose equivalent is a common industrial means of classification. Since they are complex mixtures their number average molecular weight <M>ₙ can be calculated from the equation below. (Journal of Food Engineering, 33 (1997) 221-226)
   DE=18016/<M>ₙ
Erythritol, arabitol, glycerol, xylitol, sorbitol, mannitol, lactitol and malitol.

Definition of Overrun.

Overrun is defined by the following equation

$$OR = \frac{\begin{matrix}volume .. of .. ice .. cream - \\ volume .. of .. premix .. at .. ambient .. temp\end{matrix}}{volume .. of .. premix .. at .. ambient .. temp} \times 100$$

It is measured at atmospheric pressure.

### BRIEF DESCRIPTION OF THE INVENTION

It is the object of the invention to provide a method of dispensing a food product comprising filling a container with a food product, transporting the container from the site of filling to a site at which the food product is to be dispensed, locating the container in a dispensing apparatus, and discharging food product in the container through an outlet of the container, characterised in that the container has at least two compartments (A) and (B), said compartments being gas-tightly separated from each other by an at least partially movable wall, compartment (A) containing a propellant and compartment (B) containing the food product, compartment (B) being provided with a valve.

Preferably the food product is a frozen aerated product such as an ice cream product.

By using pre-energised containers, it is possible to apply the method according to the invention in locations where no electrical power is available to dispense the manufacture and dispense ice cream.

Preferably, the filling of the container takes place by introducing the propellant into compartment (A), up to where a gauge pressure of between 1 bar and 10 bar is reached, then the food product is introduced into compartment (B) until a gauge pressure of between 5 bar and 12 bar, preferably above 8 bar, is reached.

Preferably also, the ice cream product contains freezing point depressants in an amount of between 20% and 40% w/w, preferably above 25%, and between 0% and 15% fat, preferably between 2% andl2%, the freezing point depressants having a number average molecular weight <M>ₙ following the following condition:
<M>ₙ=<−8 FAT+330

wherein FAT is the fat level in percent by weight of the product.

More preferably, the freezing point depressants are made at least a level of 98% (w/w) of mono, di and oligosaccharides.

More preferably also, the dispensing apparatus is equipped with thermal insulation means which surrounds each ice cream container and which maintains product temperature below −15° C. for up to 8 hours. It allows for locating the dispensing apparatus in places wherein no electrical power is available to maintain the temperature of the ice cream product. In an alternative preferred embodiment, the dispensing apparatus is equipped with an insulated casing for example made of insulating foam, or comprising insulating foam panels and the ice cream containers are partially covered by a generally cylindrical casing made of eutectic plates.

Preferably, the dispensing apparatus is designed to releasably hold one or more containers vertically inverted (i.e. with the valve at the bottom). More preferably, the dispensing apparatus is equipped with a storage cabinet adapted to contain additional filled containers.

### DETAILED DESCRIPTION OF THE INVENTION

The present invention will be further described with reference to the drawings wherein;

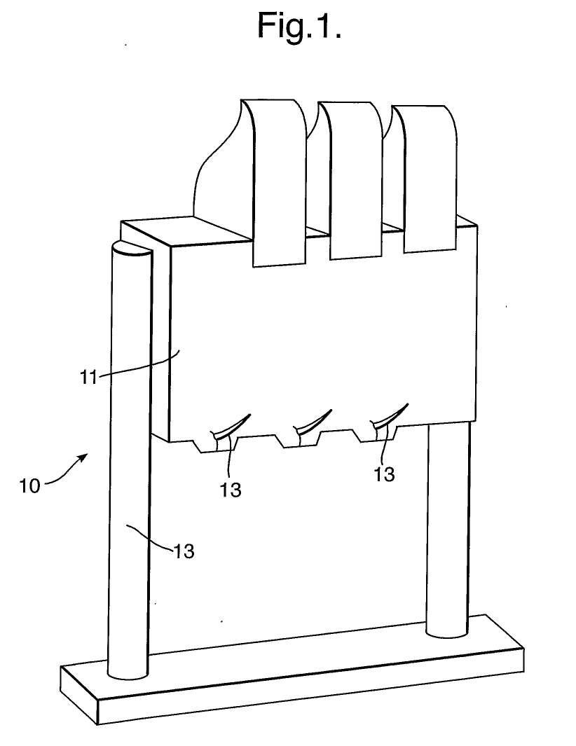

FIG. 1 is a schematic view of a dispensing unit for operating the process of the invention.

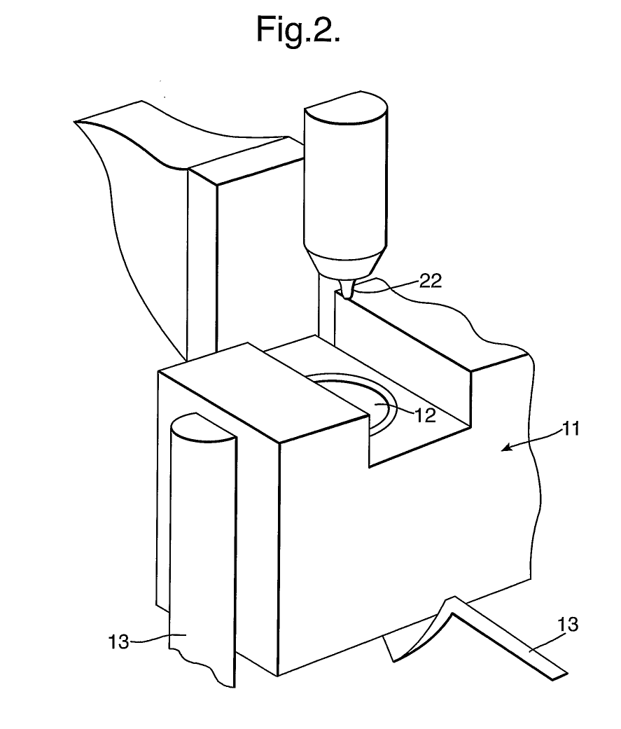

FIG. 2 is a schematic partial view of the upper part of a dispensing unit for operating the process of the invention, together with an ice cream container about to be introduces into the dispensing unit.

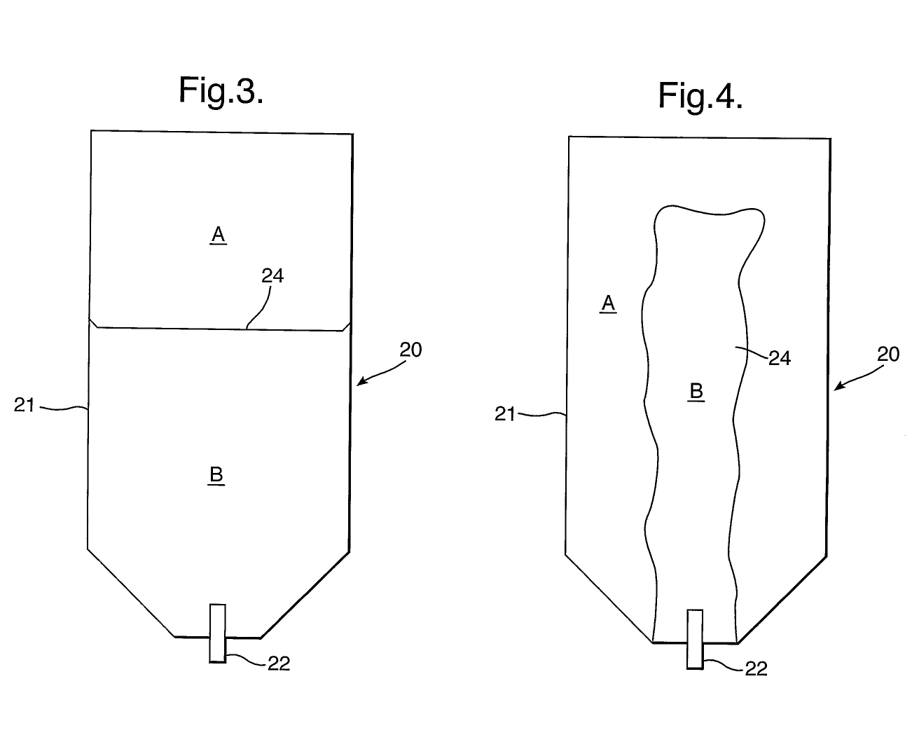

FIG. 3 is a schematic cross section of an ice cream container used in the process of the invention.

FIG. 4 is a schematic cross section of another ice cream container used in the process of the invention.

As can be seen on FIGS. 1 and 2, a dispensing unit 10 comprises an upper part 11 adapted to vertically hold individual ice cream containers 20 in wells 12, these wells can be thermally insulated. This upper part 11 is supported by a frame 13 which is adapted to be fitted on existing tables or countertops. These insulated wells 12 can be in the form of a generally cylindrical envelope preferably containing a eutectic solution. At the bottom of the upper part 11 is located, under each insulated well 12, actuating means 13 adapted to open and shut the valve 22 of the ice cream container 20 container in said well 12.

As can be seen on FIG. 3, each ice cream container 20 comprises an outer body 21 of generally cylindrical shape, equipped with a dispensing valve 22 at one end. The outer body 21 is divided in two compartments A and B said compartments being gas-tightly separated from each other by an at least partially movable wall 24, compartment (A) containing a gas under pressure (propellant) and compartment (B) containing the ice cream product, compartment (B) being provided with a valve 22. As can be seen in FIG. 3, the movable wall 24 is in the form of a piston sliding against the inside wall of the cylindrical body 21, in another embodiment disclosed in FIG. 4, the movable wall 24 can be in the form of a bag 25 attached to the valve 22.

The gas in compartment (A) can be air, it is typically at a gauge pressure of between 5 bar and 12 bar at a temperature of −18 C.

A container 20 can present on its outer body 21, a thermal insulation which can be in the form of eutectic pads forming a generally cylindrical envelope. Each container contains enough ice cream to typically dispense around 10 individual doses.

In operation, ice cream containers 20, filled with different flavoured ice creams, are inserted in their respective wells 12 in the dispensing apparatus 10. On request by a customer, or by the customer himself, the actuating means 13 corresponding to the desired ice cream are operated, the valve 22 is opened and, owing to the pressure in compartment A of the container, the ice cream contains in compartment be flows out of the container through valve 22 into e.g. a cup or a cone. When the desired dose has been delivered, valve 22 is shut.

1. A method of dispensing a food product comprising
filling a container with a food product,
transporting the container from the site of filling to a site at which the food product is to be dispensed,
locating the container in a dispensing apparatus, and
discharging food product in the container through an outlet of the container,
characterised in that the container has at least two compartments (A) and (B), said compartments being gastighlty separated from each other by an at least partially movable wall,
compartment (A) containing a propellant and compartment (B) containing the food product, compartment (B) being provided with a valve.

2. A method according to claim 1 characterised in that the filling of the container takes place by introducing the propellant into compartment (A), up to where a gauge pressure of between 1 bar and 10 bar is reached, then the food product is introduced into compartment (B) until a gauge pressure of between 5 bar and 12 bar, preferably above 8 bar, is reached.

3. A method according to claim 1 wherein wherein the food product is an ice cream product containing freezing point depressants in an amount of between 20% and 40% w/w, preferably above 25%, and between 0% and 15% fat, preferably between 2% and 12%, the freezing point depressants having a number average molecular weight <M>ₙ following the following condition:
<M>ₙ=<−8 FAT+330
Wherein FAT is the fat level in percent by weight of the product.

4. Method to claim 3 wherein the freezing point depressants are made at least a level of 98% (w/w) of mono, di and oligosaccharides.
